(19) United States
(12) Patent Application Publication
(10) Pub. No.: US 2007/0066317 A1
(43) Pub. Date: Mar. 22, 2007

(54) Method and system for planning and evaluation of radio networks

(76) Inventors: Sascha Amft, Dusseldorf (DE); Sinan Okdemir, Dusseldorf (DE); Volker Ricker, Neuss (DE)

Correspondence Address: MICHAELSON & ASSOCIATES, P.O. BOX 8489, RED BANK, NJ, 07701, US

(21) Appl. No.: 10/555,978

(22) PCT Filed: May 28, 2004
(86) PCT No.: PCT/EP04/05956

§ 371 Date: Nov. 8, 2005

(30) Foreign Application Priority Data
May 28, 2003 (EP) 03076639.8

(51) Int. Cl. H04Q 7/20

(52) U.S. Cl. 455/446

(57) ABSTRACT

Method and system for the planning and/or evaluation of a radio network, the radio network comprising at least one base station defining at least one cell. More specifically the invention provides a method and system for the planning and evaluation in existing radio networks that need coverage improvement, where the solution prioritizes the roll-out of base stations to improve coverage as perceived by the end-users.

### FIELD OF THE INVENTION

The invention relates to planning and evaluation of radio networks. More specifically the invention relates to optimizing coverage in existing radio networks and prioritizing placement of base stations.

### BACKGROUND OF THE INVENTION

Radio network planning and evaluation is used to find gaps in radio coverage and to find the location where to build a new base station.

WO90/10342 provides a method and a system for planning of radio cells. It utilizes an exclusion matrix calculated on the basis of measured field strengths and an iterative allocating algorithm, which allows an adaptation of the cell planning to prevail traffic demand.

WO96/36188 provides a method of and a device for estimating system requirements of a radio telecommunication network.

EP1294208 provides a method and system for the planning and/or evaluation of radio networks, especially CDMA radio networks. It takes into account cell breathing due to traffic changes and therefore the planning involves the calculation of a link budget for each pixel and of a noise rise for each cell.

WO93/15591 provides a method and a system for planning a cellular radio network using simulations for subscriber mobility.

Problem Definition

There are no solutions for the planning and evaluation in existing radio networks that need coverage improvement, where the solution prioritizes the roll-out of base stations to improve coverage as perceived by the end-users.

Aim of the Invention

The aim of the invention is to provide a method and system for the planning and evaluation in existing radio networks that need coverage improvement, where the solution prioritizes the roll-out of base stations to improve coverage as perceived by the end-users.

### SUMMARY OF THE INVENTION

The present invention provides a solution for planning and evaluation in existing radio networks that need coverage improvement, where the solution can prioritize the roll-out of base stations to improve coverage as perceived by the end-users.

According to an aspect of the invention a method and system are provided for the planning and/or evaluation of a radio network, the radio network comprising at least one base station defining at least one cell. The method can comprise the following steps or a subset of the following steps, where the system comprises means to handle these steps:
Dividing at least part of at least one service area into pixels.
Identifying at least one uncovered pixel by evaluating whether or not the at least one of the pixels is covered by the at least one cell. A coverage prediction model and a population distribution model can be used for this. A measured coverage data and a population distribution model can be used for this. A coverage prediction model and an environment characteristics model can be used for this. A measured coverage data and an environment characteristics model can be used for this.
Weighing the at least one uncovered pixel.
Determining a sum of new covered pixels by virtually placing a new base station on the at least one uncovered pixel. The sum of new covered pixels can be a weighed sum of new covered pixels.
Determining at least one candidate pixel. This can be done by selecting the at least one uncovered pixel for which the sum of new covered pixels is highest. The selecting the at least one uncovered pixel can evaluate whether or not the sum of new covered pixels is above a threshold value.
Determining whether or not there are two or more adjacent candidate pixels.
Defining an adjacent pixels area.
Determining a center of gravity of the adjacent pixels area.
Identifying at least one already covered pixel in an living area surrounding the at least one uncovered pixel by evaluating whether or not the at least one already covered pixel is covered by the at least one cell;
Determining for the at least one uncovered pixel a sum of already covered pixels in the living area surrounding the at least one uncovered pixel.
Determining for the at least one uncovered pixel a new sum of covered pixels in the living area surrounding the at least one uncovered pixel, after virtually placing the new base station on the at least one uncovered pixel;
Prioritizing the at least one candidate pixel by evaluating the difference between the sum of already covered pixels in the living area surrounding the at least one uncovered pixel and the new sum of covered pixels in the living area surrounding the at least one uncovered pixel, after virtually placing a new base station on the at least one uncovered pixel.

A real base station can be placed on the candidate pixel. A real base station can also be placed on the center of gravity of the adjacent pixels area.

### BRIEF DESCRIPTION OF THE DRAWINGS

The invention will be explained in greater detail by reference to exemplary embodiments shown in the drawings, in which:

FIG. 1 shows a flowchart of the planning and evaluation of the radio network according to an exemplary embodiment of the invention.

FIG. 2 shows a sub-result of the planning and evaluation of the radio network according to an exemplary embodiment of the invention.

FIG. 3 shows another sub-result of the planning and evaluation of the radio network according to an exemplary embodiment of the invention.

FIG. 4 shows another sub-result of the planning and evaluation of the radio network according to an exemplary embodiment of the invention.

FIG. 5 shows another sub-result of the planning and evaluation of the radio network according to an exemplary embodiment of the invention.

FIG. 6 shows another sub-result of the planning and evaluation of the radio network according to an exemplary embodiment of the invention.

FIG. 7 shows another sub-result of the planning and evaluation of the radio network according to an exemplary embodiment of the invention.

FIG. 8 shows another sub-result of the planning and evaluation of the radio network according to an exemplary embodiment of the invention.

FIG. 9 shows a flowchart used for a prioritization in the planning and evaluation the radio network according to an exemplary embodiment of the invention.

### DETAILED DESCRIPTION OF THE INVENTION

For the purpose of teaching of the invention, preferred embodiments of the method and system of the invention are described in the sequel. It will be apparent to the person skilled in the art that other alternative and equivalent embodiments of the invention can be conceived and reduced to practice without departing from the true spirit of the invention, the scope of the invention being only limited by the claims as finally granted.

### Preferred Embodiment

The planning and evaluation process described here allows the generation of a countrywide radio network planning within relatively short periods of time. Depending on the accuracy and actuality of the input data in use, the quality of the planning and evaluation output can be reasonably high. A key input is up-to-date data about the population distribution. With the knowledge of local or regional varieties in age, mobility, education or purchasing power the model can be further tuned.

Planning for Indoor Coverage

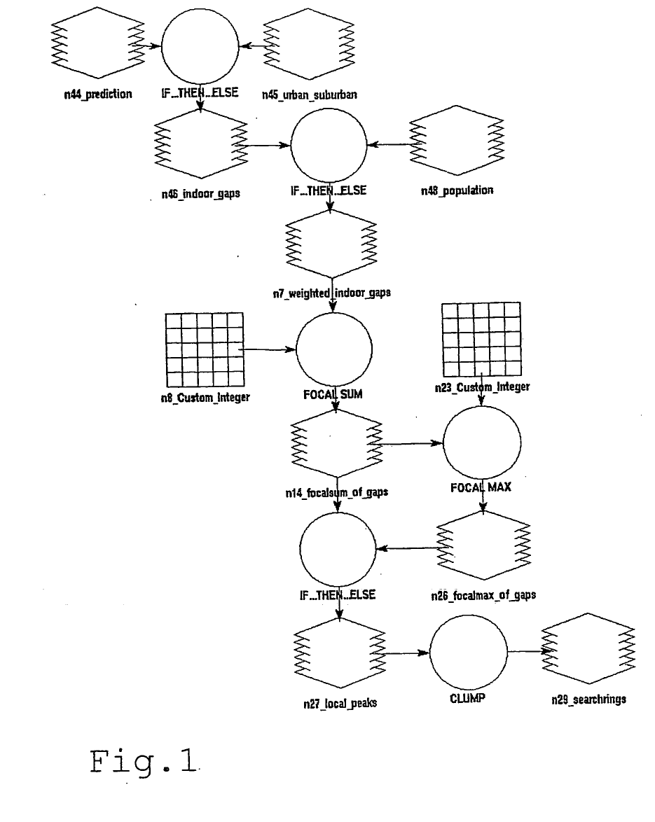

FIG. 1 shows a flow chart of the planning approach. The calculation uses the commercially available software product ERDAS Imagine®, which is a widely used tool for raster processing. By use of this tool, a raster array representing the predicted or measured current coverage situation is combined with the population distribution in order to find accumulations of uncovered population within the reach of a potential base station. All steps of the model will be discussed in detail.

The analysis is performed using a raster size of 100×100 m. Higher resolution would increase data volumes and processing time to unacceptable levels.

Step 1 (3): The functional building block 1 identifies raster pixel which are currently uncovered at the respective field strength threshold by combining the field strength raster n_{—}44_prediction (1) with the clutter classes “urban”, “suburban” and “rural” n45_urban_suburban (2), as the radio wave propagation and likewise a potential base station's range depends on the building density. The applied thresholds could be for example:
−65 dBm for urban area
−72 dBm for suburban and rural area

resulting in a 1 bit-raster n46_indoor_gaps (4) with pixel value “1” representing uncovered areas and “0” depicting covered areas.

EITHER 1
IF ( (n45_urban_suburban==1 and n44_prediction<-72dBm)
or ( n45_urban_suburban!=1 and n_44prediction<-65dBm))
OR 0 OTHERWISE

Step 2 (6): Building block 2 weights the result with the number of inhabitants per pixel n48_population (5). The algorithm uses the maximum of daytime and nighttime population on a pixel level, i.e. pure residential areas are counted mostly with their nighttime inhabitants while industrial park areas are valued with their daytime population. Thus the accumulated, nationwide figure exceeds the real country's number of inhabitants, as commuters may be counted twice.

The resulting 8 bit-raster n7_weighted_indoor_gaps (7) indicates the number of inhabitants if the pixel is uncovered, otherwise “0”.

EITHER n48_population
IF ( (n46_indoor_gaps==1 )
OR 0 OTHERWISE

Step 3 (9): Based on the assumption of a base station's range of 500 m, step 3 sums—for each pixel—all uncovered population that is located within that range (i.e. within a range of 5 pixel). The coverage area is approximated a being circular. It thus simulated—for each pixel—how many population could be covered if the BTS would be placed right there. The resulting raster n4_focalsum_of_gaps (10) has an information depth of 16 bit.

FOCAL SUM ( n7_weighted_indoor_gaps , n8_Custom_Integer )

Steps 4: At this point, the optimal strategy to find the most efficient base station locations would be to identify the pixel having the absolute maximum value in n14_focalsum_of_gaps (10), assume a BTS being placed there, calculate a field strength prediction and restart from step 1. The approach, however, is not realistic as for a nationwide planning as processing time would be unacceptable. Instead, the automated planning approach is aimed to find local maximums, i.e. location with a maximum number of populations within coverage range, by choosing—pixel per pixel—the maximum value from n14_focalsum_of_gaps (10) in 500 m neighborhood. A local maximum requires the current pixel value to be equal to the maximum pixel value in 500 m perimeter. As a second condition, a local maximum is taken into account only if a particular threshold (i.e. a particular number of inhabitants to be covered by that BTS candidate) is exceeded. These two block 4 and 5 result in a 16 bit unsigned raster n27_local_peaks (15) where all pixel that fulfill the two conditions carry the population in 500 m neighborhood, all others hold the value “0”.

Block 4 (12):

FOCAL MAX ( n14_focalsum_of_gaps , n23_Custom_Integer )

The ERDAS build-in function “FOCAL MAX” returns the maximum of the pixel values in the focal window (focus) around each pixel of the input raster. The focus is defined by a customized 11×11 matrix n23_Custom_Integer (11) shaped like a circle as depicted below:

$$n23\_Custom \_Integer = [ \begin{matrix}0 & 0 & 0 & 0 & 0 & 1 & 0 & 0 & 0 & 0 & 0 \\ 0 & 0 & 0 & 1 & 1 & 1 & 1 & 1 & 0 & 0 & 0 \\ 0 & 0 & 1 & 1 & 1 & 1 & 1 & 1 & 1 & 0 & 0 \\ 0 & 1 & 1 & 1 & 1 & 1 & 1 & 1 & 1 & 1 & 0 \\ 0 & 1 & 1 & 1 & 1 & 1 & 1 & 1 & 1 & 1 & 0 \\ 1 & 1 & 1 & 1 & 1 & 1 & 1 & 1 & 1 & 1 & 1 \\ 0 & 1 & 1 & 1 & 1 & 1 & 1 & 1 & 1 & 1 & 0 \\ 0 & 1 & 1 & 1 & 1 & 1 & 1 & 1 & 1 & 1 & 0 \\ 0 & 0 & 1 & 1 & 1 & 1 & 1 & 1 & 1 & 0 & 0 \\ 0 & 0 & 0 & 1 & 1 & 1 & 1 & 1 & 0 & 0 & 0 \\ 0 & 0 & 0 & 0 & 0 & 1 & 0 & 0 & 0 & 0 & 0\end{matrix} ]$$

Block 5 (14):

```
EITHER n14_focalsum_of_gaps
    IF ( n14_focalsum_of_gaps==n26_focalmax_of_gaps
and
    n14_focalsum_of_gaps>1500)
OR 0 OTHERWISE
```

As the local maximum might consist of more than one pixel, i.e. more than one raster dot fulfilling the conditions mentioned above where only one potential base station would have to be placed, the following block does a grouping of adjacent pixel. The corresponding function is called “CLUMP” (16) and performs a contiguity analysis of the raster n27_local_peaks (15) where each separate raster region/clump is recoded to a separate class. The output is the single layer raster n_{—}29_searchrings (17) in which the contiguous areas are numbered sequentially. The function CLUMP (16) takes 8 neighboring pixel into account as shown below.

Block 6 (16):

CLUMP ( n27_local_peaks , 8 )

The resulting 32-bit raster n29_searchrings (17) contains for each clump the consecutive number as well as the weight (here the amount of population related to a potential BTS). The more pixel belonging to a particular class, the larger is the tolerance area in which to place the BTS.

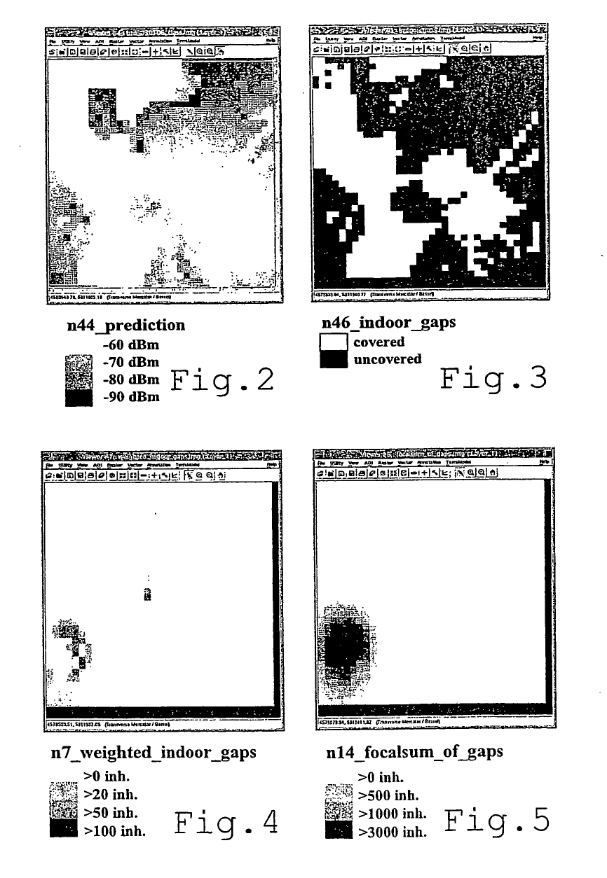

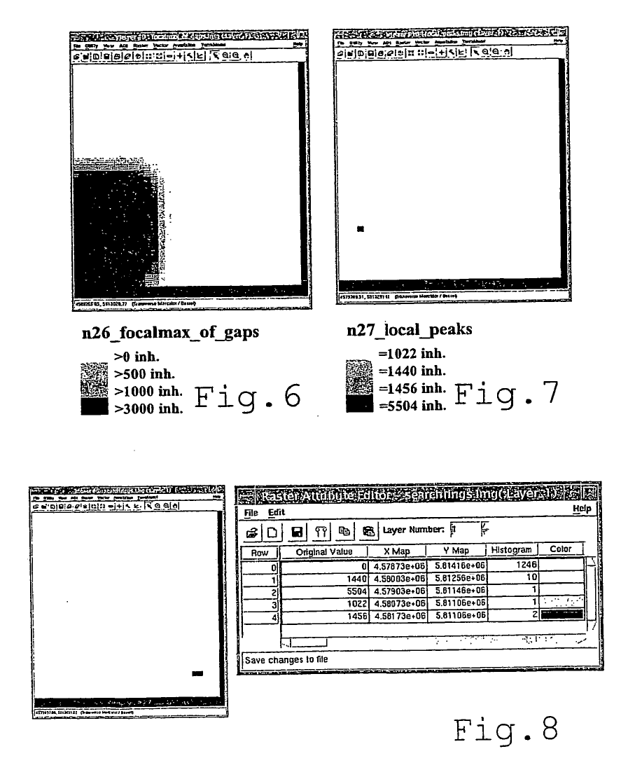

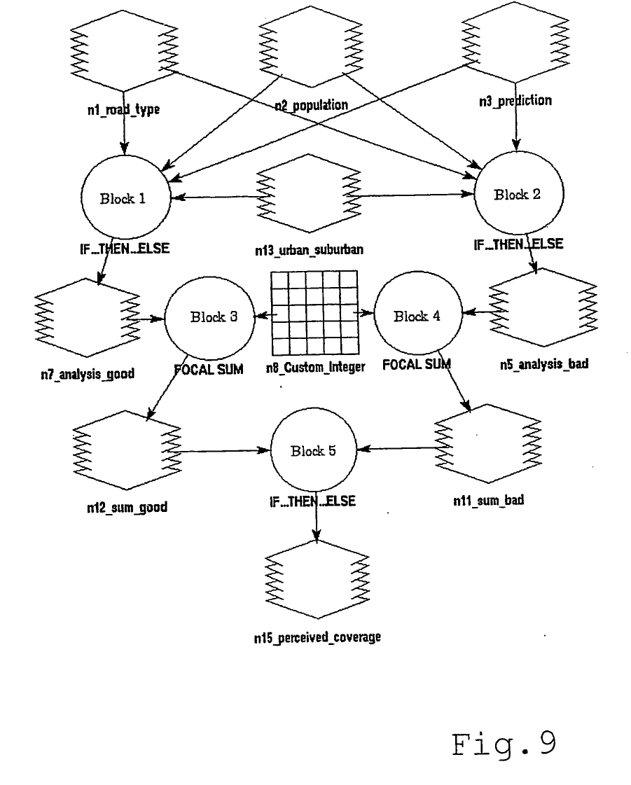

FIG. 2, FIG. 3, FIG. 4, FIG. 5, FIG. 6 and FIG. 7 display the step-by-step results for an area of 3 km×3.5 km in the center of Berlin. In this example, there are 4 new BTS locations found. The output of block 6 (16) “CLUMP” results in the raster as displayed in FIG. 8. The four potential BTS locations are numbered sequentially (column “row”) and carrying the value of the population to be covered (column “Original Value”). According to the automated planning, the BTS candidate 1 could be placed anywhere within the yellow region while still covering the calculated amount of 1440 inhabitants.

As the approach described above cannot guarantee a minimum inter-site distance, the next step can be to delete all candidates with a distance less than the coverage range from the BTS list. Therefore the programming language “C” is used:

As the applied coordinate system is Transverse Mercator (Gauss-Krüger, where in the close-up range a rectangular grid is applied, site distances in the close neighborhood can—with an acceptable inaccuracy—be calculated following Pythagoras theorem as
\sqrt{(Xₛᵢₜₑ₁−Xₛᵢₜₑ₂)²+(Yₛᵢₜₑ₁−Yₛᵢₜₑ₂)²}

In order to improve the quality of the process, the steps described above are repeated to up to 3 iterations. Therefore the attainable coverage is simulated with a set of BTS consisting of all BTS on air plus the set of BTS candidates to be built.

Planning for Road Coverage

The high-level approach for road coverage planning resembles the one applied for indoor coverage. The field strength thresholds and minimum coverage requirements as well as assumed BTS coverage range are adjusted. The model starts with raster-oriented measurement data, e.g. on highways and important other roads. The 8-bit raster n1_measurement_campaign (1) represents the measured field strength anywhere drive tests took place or “0” otherwise.

Block 1 (3) marks those pixel, where a field strength level to be defined is not exceeded, with “1” if highway or “2” if other road (n17_road_type (2)). Highways and other road can be given distinctive threshold values to account for their different importance.

Block 1 (3):

```
EITHER 1
IF ( n17_road_type==”HIGHWAY”1 &&
n1_measurement_campaign<-98dBm)
OR ( EITHER 2
    IF ( n17_road_type==”OTHER_ROAD” and
        n1_measurement_campaign<-100dBm)
    OR 0 OTHERWISE )
OTHERWISE
```

The resulting raster2-bit raster is used as input for a focal analysis. As the field strength requirement differ from the indoor approach, the assumed coverage range differs as well. A coverage zone can be deduced from Okumura-Hata theorem as 3000 m. Based on this range, block 2 (9) sums—for each pixel—all uncovered and weighted (1 or 2) road segments that are located within that area (i.e. within a range of 30 pixel). The coverage area is approximated a being circular. It thus simulated—for each pixel—what road section could be covered if the BTS would be placed right there. The resulting raster n4_focalsum_highways (10) has an information depth of 16 bit.

Block 2 (9):

FOCAL SUM ( n13_no_incar_coverage, n3_Custom_Integer )

Blocks 3 and 4 are aimed to find local maximums, i.e. location with a maximum number of uncovered road pixel within coverage range, by choosing—pixel per pixel—the maximum value from n4_focalsum_highways (10) in a 3000 m neighborhood. A local maximum requires the current pixel value to be equal to the maximum pixel value in 3000 m perimeter. As a second condition, a local maximum is taken into account only if a particular threshold (i.e. a particular segment length) is exceeded. These two blocks result in a 16 bit unsigned raster n8_local_peaks (15) where all pixel that fulfill the two conditions are assigned the number of uncovered pixel in 3000 m neighborhood, all others carry the value “0”.

Block 4 (12):

FOCAL MAX ( n4_focalsum_highways , n9_Custom_Integer )

Block 4 returns the maximum of the pixel values in the focal window (focus) around each pixel of the input raster. The focus is defined by a customized 61×61 matrix n9_Custom_Integer (11) shaped like a circle.

Block 3 (14):

```
EITHER n4_focalsum_highway
    IF ( n4_focalsum_highways==n5_focalmax_highways
and
            n14_focalsum_highways>20)
OR 0 OTHERWISE
```

The threshold of 20 pixel that has to be exceeded to justify a BTS corresponds to either 10 pixel on highway or 20 pixel on other roads or any combination of that.

The final block 5 (16) does a grouping of adjacent pixel by use of the function “CLUMP”, performing a contiguity analysis on the raster n8_local_peaks (15). Each separate raster region/clump is recoded to a separate class. The output is the single layer raster n_{—}11_searchrings (17) in which the contiguous areas are numbered sequentially.

Block 5:

CLUMP ( n8_local_peaks , 8 )

The resulting 32-bit raster n11_searchrings (17) contains—for each clump—the consecutive number as well as the weight (i.e. the number of road pixel related to a potential BTS). The tolerance area in which to place the BTS is larger the more pixel belong to the corresponding class.

The resulting set of BTS candidates for road coverage improvement is checked for a minimum inter site distance between each other as well as between road and indoor BTS and—if needed—cleared. Two or more iterations provide an improved planning quality.

Rollout Prioritization for new BTS Locations

Experience taught that coverage plots denoting the covered area at a field strength of −95 dBm do not reflect the customers' perception. An average customer is not only interested in coverage at home but is moving and therefore also wants to use his cell phone in the surrounding area. Besides, uninhabited areas such as forest and countryside do also not play a major role in a customer's quality perception. Thus, an alternative approach to describe network coverage has to assume a mobile customer and focus on settled regions only.

The measure “Perceived Coverage” fulfills this requirements as it is calculated as follows: For each raster pixel the model calculates a percentage of covered pixel in a 20 km perimeter, as this is the area in which an average customer usually moves. To be counted as covered, the predicted field strength at a particular pixel has to exceed

−60 dBm in urban areas

−70 dBm in suburban and rural areas

−85 dBm on main roads and BAB (highways).

Unpopulated pixel (forest, agricultural areas, watercourses) are not taken into consideration. “Perceived Coverage” better represents the customers' impression by putting higher weight on areas, where a mobile phone is normally used.

The raster layer “Perceived Coverage” is calculated as follows:

Block 104 marks all relevant pixel, i.e. those fulfilling the field strength conditions, as covered (value: “1”), all others (not covered or not relevant as countryside) are given the value “0”. The inverted analysis is performed in Block 106, where all uncovered but relevant pixel are marked “1”, all others (covered or irrelevant) are assigned the value “0”.

Block 104:

```
EITHER 1
IF (( n1_road_type (101) > 0 AND n3_prediction (103)
    >= −86dBm) OR
    ( n2_population (102) > 0 AND
        (n3_prediction (103) >= −60dBm OR
        (n3_prediction (103)>= −70dBm AND
n13_urban_suburban (105)!=1))))
OR 0 OTHERWISE
```

Block 106:

```
EITHER 1
IF (( n1_road_type (101) > 0 AND n3_prediction (103)
    < −86dBm) OR
    ( n2_population (102) > 0 AND
          (n3_prediction (103) < −70dBm OR
      (n3_prediction (103) < −60dBm AND
        n13_urban_suburban (105)==1))))
OR 0 OTHERWISE
```

The resulting 1-bit raster n7_analysis_good (107) and n5_analysis_bad (111) are input to blocks 108 and 110 where all good (block 108) respectively all bad (block 110) pixel within the focal window are counted. The focus has a circular shape with radius 2000 pixel, representing the 20 km mobility radius. The output raster have an information depth of 16 bit unsigned and provide information about the number of good respectively bad pixel in a 20 km perimeter.

Block 108:

FOCAL SUM(n7_analysis_good (107),n8_Custom_Integer (109))

Block 110:

FOCAL SUM(n5_analysis_bad (111),n8_Custom_Integer (109))

The final step is to compute—for each pixel—the ratio of good and bad pixel in the neighborhood. The resulting 8-bit raster n15_perceived_coverage (115) is assigned a value between 0 and 100, representing the percentage of good pixel in relation to the total number of relevant pixel and therewith the “Perceived Coverage”.

Block 113:

EITHER
INTEGER( 100 * FLOAT ( n12_sum_good (112)) /
FLOAT ( n12_sum_good (112)+ n11_sum_bad (114) ))
IF ( n12_sum_good (112)+ n11_sum_bad (114) > 0 )
OR 0 OTHERWISE

Mapping the possible increase in perceived coverage on the found new base station locations for indoor and road coverage shows which new base stations have the highest impact on perceived coverage. The new base stations with highest impact can be build first. Such for all new base station locations a priority can be given.

1. Method for the planning and/or evaluation of a radio network, the radio network comprising at least one base station defining at least one cell, the method comprising the steps of
dividing at least part of at least one service area into pixels;
identifying at least one uncovered pixel by evaluating whether or not the at least one of the pixels is covered by the at least one cell;
determining a sum of new covered pixels by virtually placing a new base station on the at least one uncovered pixel;
determining at least one candidate pixel.

2. Method according to claim 1 in which the step of identifying at least one uncovered pixel uses a coverage prediction model and a population distribution model.

3. Method according to claim 1 in which the step of identifying at least one uncovered pixel uses a measured coverage data and a population distribution model.

4. Method according to claim 1 in which the step of identifying at least one uncovered pixel uses a coverage prediction model and an environment characteristics model.

5. Method according to claim 1 in which the step of identifying at least one uncovered pixel uses a measured coverage data and an environment characteristics model.

6. Method according to claim 1 in which the method further comprises the step of
weighing the at least one uncovered pixel;
and the sum of new covered pixels is a weighed sum of new covered pixels.

7. Method according to claim 1 in which the step of determining the at least one candidate pixel is performed by selecting the at least one uncovered pixel for which the sum of new covered pixels is highest.

8. Method according to claim 7 in which the selecting the at least one uncovered pixel evaluates whether or not the sum of new covered pixels is above a threshold value.

9. Method according to claim 1 in which the method further comprises the step of
determining whether or not there are two or more adjacent candidate pixels;
defining an adjacent pixels area;
determining a center of gravity of the adjacent pixels area.

10. Method according to claim 1 in which the method further comprises the steps of
identifying at least one already covered pixel in an living area surrounding the at least one uncovered pixel by evaluating whether or not the at least one already covered pixel is covered by the at least one cell;
determining for the at least one uncovered pixel a sum of already covered pixels in the living area surrounding the at least one uncovered pixel;
determining for the at least one uncovered pixel a new sum of covered pixels in the living area surrounding the at least one uncovered pixel, after virtually placing the new base station on the at least one uncovered pixel;
prioritizing the at least one candidate pixel by
evaluating the difference between the sum of already covered pixels in the living area surrounding the at least one uncovered pixel and
the new sum of covered pixels in the living area surrounding the at least one uncovered pixel, after virtually placing a new base station on the at least one uncovered pixel.

11. Method according to claim 1 in which the method further comprises the step of placing a real base station on the candidate pixel.

12. Method according to claim 9 in which the method further comprises the step of placing a real base station on the center of gravity of the adjacent pixels area.

13. System for the planning and/or evaluation of a radio network, the radio network comprising at least one base station defining at least one cell, the system comprising
means for dividing at least part of at least one service area into pixels;
means for identifying at least one uncovered pixel by evaluating whether or not the at least one of the pixels is covered by the at least one cell;
means for determining a sum of new covered pixels by virtually placing a new base station on the at least one uncovered pixel;
means for determining at least one candidate pixel.

14. System according to claim 13 in which the means for identifying at least one uncovered pixel comprises a coverage prediction model and a population distribution model.

15. System according to claim 13 in which the means for identifying at least one uncovered pixel comprises a measured coverage data and a population distribution model.

16. System according to claim 13 in which the means for identifying at least one uncovered pixel comprises a coverage prediction model and an environment characteristics model.

17. System according to claim 13 in which the means for identifying at least one uncovered pixel comprises a measured coverage data and an environment characteristics model.

18. System according to claim 13 in which the system further comprises
means for weighing the at least one uncovered pixel;
and the sum of new covered pixels is a weighed sum of new covered pixels.

19. System according to claim 13 in which the means for determining the at least one candidate pixel comprises a means for selecting the at least one uncovered pixel for which the sum of new covered pixels is highest.

20. System according to claim 19 in which the means for selecting the at least one uncovered pixel comprises means for evaluating whether or not the sum of new covered pixels is above a threshold value.

21. System according to claim 13 in which the system further comprises
means for determining whether or not there are two or more adjacent candidate pixels;
means for defining an adjacent pixels area;
means for determining a center of gravity of the adjacent pixels area.

22. System according to claim 13 in which the system further comprises
means for identifying at least one already covered pixel in an living area surrounding the at least one uncovered pixel and means for evaluating whether or not the at least one already covered pixel is covered by the at least one cell;
means for determining for the at least one uncovered pixel a sum of already covered pixels in the living area surrounding the at least one uncovered pixel;
means for determining for the at least one uncovered pixel a new sum of covered pixels in the living area surrounding the at least one uncovered pixel, after virtually placing the new base station on the at least one uncovered pixel;
means for prioritizing the at least one candidate pixel with
means for evaluating the difference between the sum of already covered pixels in the living area surrounding the at least one uncovered pixel and
the new sum of covered pixels in the living area surrounding the at least one uncovered pixel, after virtually placing a new base station on the at least one uncovered pixel.
